(19) United States
(12) Patent Application Publication
(10) Pub. No.: US 2003/0079586 A1
(43) Pub. Date: May 1, 2003

(54) Brick recycling method and apparatus

(76) Inventor: John Zukley, Huntersville, NC (US)

Correspondence Address: DOUGHERTY, CLEMENTS & HOFER, 1901 ROXBOROUGH ROAD, SUITE300, CHARLOTTE, NC, 28211, US

(21) Appl. No.: 10/002,415

(22) Filed: Oct. 25, 2001

(51) Int. Cl. B26D 5/20; B26D 1/00

(52) U.S. Cl. 83/13; 83/76.8

(57) ABSTRACT

An improved method and apparatus for recycling demolition brick for reuse in new construction. The bricks are recycled by having mortar removed from the demolition bricks, then stacking the recycled bricks for shipment. An automated process having seven stations is utilized from removing mortar from the demolition brick and stacking the brick. The first station includes a sorting area where the demolition brick is introduced into the automated process. The second station is a first cutting area where mortar is removed from the back surface of the brick. In the third station, the demolition brick is secured in a clamp and an image is taken of the front surface of the brick. The imaging data is used by the fourth station where cutting devices remove mortar from opposing ends of the demolition brick. Similarly, imaging data is utilized by the fifth station where a third cutting device removes mortar from the top and bottom of the demolition brick. At the sixth station, a loading arm removes the brick from the clamp and positions the brick on a shelf for placement onto a pallet. The bricks are properly stacked on a pallet at the seventh station for transporting to a site for reuse.

### BACKGROUND OF THE INVENTION

1) Field of the Invention

The present invention relates to a method and apparatus for recycling used brick, and most particularly, to a method and apparatus for mechanically cleaning the brick of attached mortar so that the brick can be used in new construction. 2) Prior Art

Used bricks come from a variety of sources, such as the demolition of public buildings, abandoned factories, homes and other structures. Most bricks have structural integrity for hundreds of years and are suitable for reuse in construction. Moreover, recycled brick is also aesthetically pleasing by allowing an architect to create the appearance of antique while having a new structure.

However, demolition bricks, encrusted with mortar, must have the mortar cleaned from them before being reused. Currently, mortar is cleaned from bricks by manual labor, a time extensive and expensive process. Because of the expense of recycling used bricks, most bricks are landfilled which is costly in addition to being environmentally wasteful.

In addition to reducing landfill waste, recycling bricks also conserves energy by reducing the number of new bricks produced. The creation of a new brick is energy intensive requiring high heat over a long period of time to sufficiently bake the brick.

What is needed is a cost-effective method and apparatus for recycling used brick. Particularly needed is an automated method and apparatus for removing mortar from used bricks so that the bricks can be reused in construction. Further needed is for the automated apparatus to be easily transportable to the demolition site.

### SUMMARY OF THE INVENTION

The present invention is a demolition brick recycling method and apparatus. In particular, the present invention provides a method and apparatus for removing mortar from demolition bricks so that the bricks can be reused in new construction.

In the broadest sense, the present invention relates to a brick recycling process having an automated computer controlled system for removing mortar from demolition bricks. The process includes the steps of providing a first device for holding a brick. Thereafter mortar is removed from the rear, opposing ends, top and bottom of the brick. Preferably, the process includes the steps of providing first, second and third cutting devices and removing mortar with the cutting devices from respective rear surface, opposing ends, and top and bottom surfaces of the brick. Optionally, the process further includes the steps of providing an imaging device and determining with the imaging device the position of the brick.

In the broadest sense, the present invention also relates to an automated brick recycling apparatus having a first cutting device for removing mortar from the rear of brick, a second cutting device for removing mortar from opposing ends of the brick, a third cutting device for removing mortar from the top and bottom of the brick, and an imaging device for determining the orientation of the brick. The apparatus also includes at least one transporter device for transporting the brick from the first cutting device to the second and third cutting devices. Additionally, a computer is integrated with, and controls, the cutting devices, imaging device and transporter. Optionally, the cutting devices are saws.

### OBJECTS OF THE INVENTION

The principal object of the present invention is to provide an improved method and apparatus for recycling demolition bricks for reuse in new construction.

Another object of the invention is for the apparatus to be movable for on-site recycling of demolition bricks.

A further object of this invention is to provide an automated method of recycling demolition bricks by removing mortar from the bricks.

Another object of the invention is to provide a method for determining the orientation of the demolition brick and aligning cutting devices according to the brick's orientation for removal of mortar from the brick.

A further object of the invention is to provide an automated method for stacking the recycled bricks.

### BRIEF DESCRIPTION OF THE DRAWINGS

The foregoing and other objects will become more readily apparent by referring to the following detailed description and the appended drawings in which:

FIG. 1 is a top view of a demolition brick recycling process having two lines with seven stations housed within a movable trailer;

FIG. 2 is perspective view of one of the brick recycling lines showing the following six demolition brick recycling stations: sorting station, first cutting station, clamping and imaging station, second cutting station, third cutting station, and clamp release station prior to stacking the demolition brick;

FIG. 3 is a perspective view of the third station showing a demolition brick secured within a clamp with the face-side upwards, and an imaging device for determining the orientation of the demolition brick;

FIG. 4 is a perspective view of a transporter for delivering the demolition brick from the second station to the third station;

FIG. 4A is a perspective view, partially exploded, of the transporter shown in FIG. 4;

FIG. 5 is a perspective view of the fourth station showing the demolition brick secured within the clamp and further showing a cutting apparatus for removing mortar from opposing ends of the demolition brick;

FIG. 6 is a perspective view of the fifth station showing the demolition brick secured within the clamp and further showing a cutting device for removing mortar from the top and bottom of the brick;

FIG. 7 is a perspective view of the sixth station showing a loading arm for removing the demolition brick from the clamp and for positioning the brick for stacking onto a pallet; and

FIG. 8 is a perspective view of the seventh station showing a pallet of recycled bricks and having a pair of spacers therethrough for handling by a forklift.

### DESCRIPTION OF THE PREFERRED EMBODIMENTS

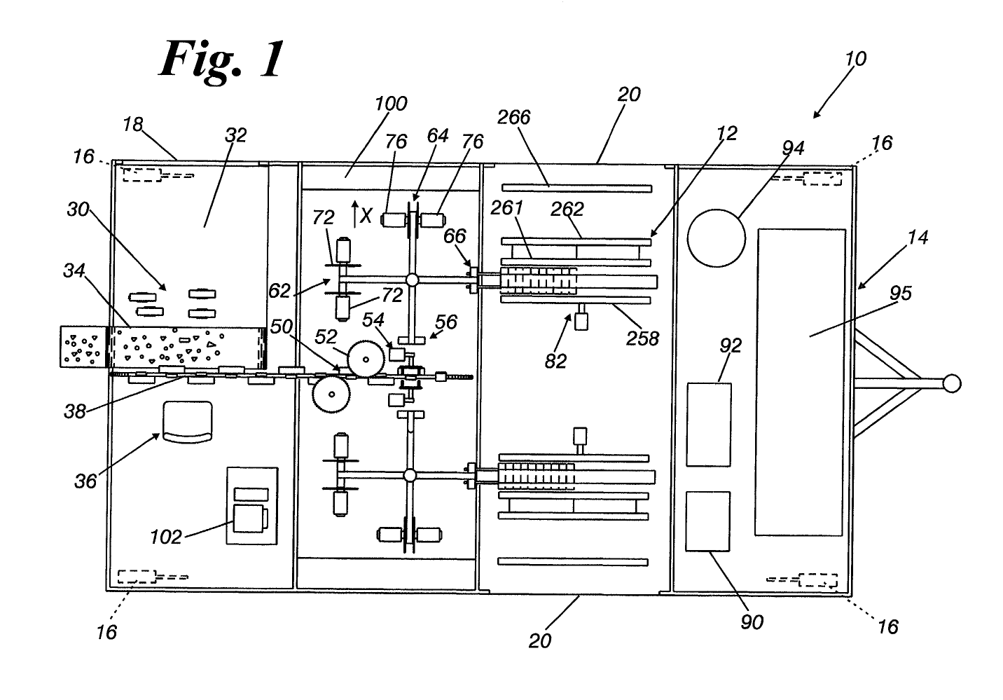

Referring now to the drawings, and particularly to FIG. 1, the invented demolition brick recycling method and apparatus 10 reclaims demolition bricks from public buildings, abandoned factories, houses and other structures for reuse in construction. In particular, the present invention utilizes an automated process to mechanically remove mortar from demolition bricks and to stack the bricks on a pallet 12 for delivery to markets where the brick can be used as a new material.

The brick recycling apparatus 10 is installed in a movable trailer 14 so that brick reclaiming can occur at the demolition site. The trailer 14 complies with federal and state regulations for use on highways and is approximately 19′ in length. Hydraulic pistons 16 are attached at the bottom four corners of the trailer 14 for leveling the trailer 14 at the demolition site. The trailer 14 has a demolition material entrance 18 and exits 20 for removing the pallet 12 of recycled brick.

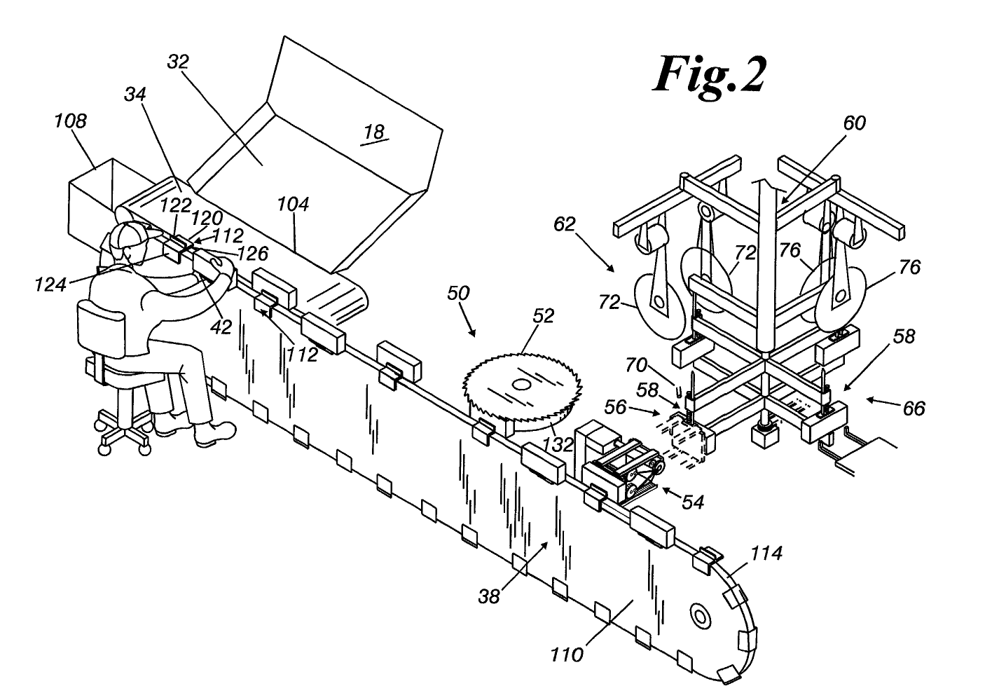

The trailer 14 houses two brick recycling lines having seven demolition brick recycling stations. The first station 30 receives demolition material through the trailer entrance 18 and includes a sorting table 32 having a first conveyor 34, an operator workstation 36 for separating demolition bricks from demolition wastes and a second conveyor 38. An operator removes the demolition brick from the sorting table 32 and places the bricks front face 42 down (FIG. 2) on the second conveyor 38 for delivery to the second station 50. For referencing purposes, the front face 42 of the brick is the face which had formed the exterior surface of the demolished building and consequently is a flush surface without mortar.

The second station 50 includes a first cutting apparatus 52 for removing mortar from the back surface of the demolition brick. The back surface is the surface opposed to the front surface. Thereafter, a transporter 54 delivers the demolition brick from the second conveyor 38 to the third station 56.

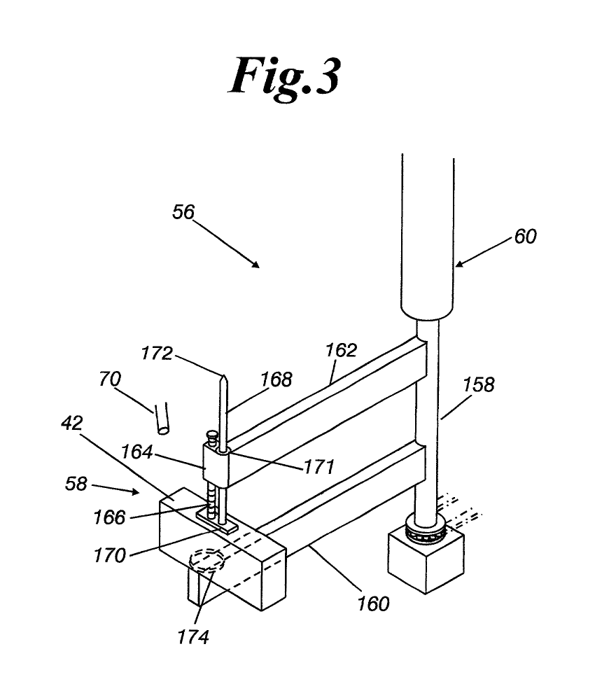

The third station 56, shown in FIGS. 2 and 3, includes a clamping device 58 for securing the demolition brick to a carrier 60 and an imaging device 61. The imaging device 61 digitally images the demolition brick in order to determine the orientation of the demolition brick within the clamping device 58 and to identify the interface between the demolition brick and mortar thereon. The carrier 60 delivers the demolition brick in sequence to stations four 62, five 64 and six 66, as illustrated in FIGS. 1 and 2.

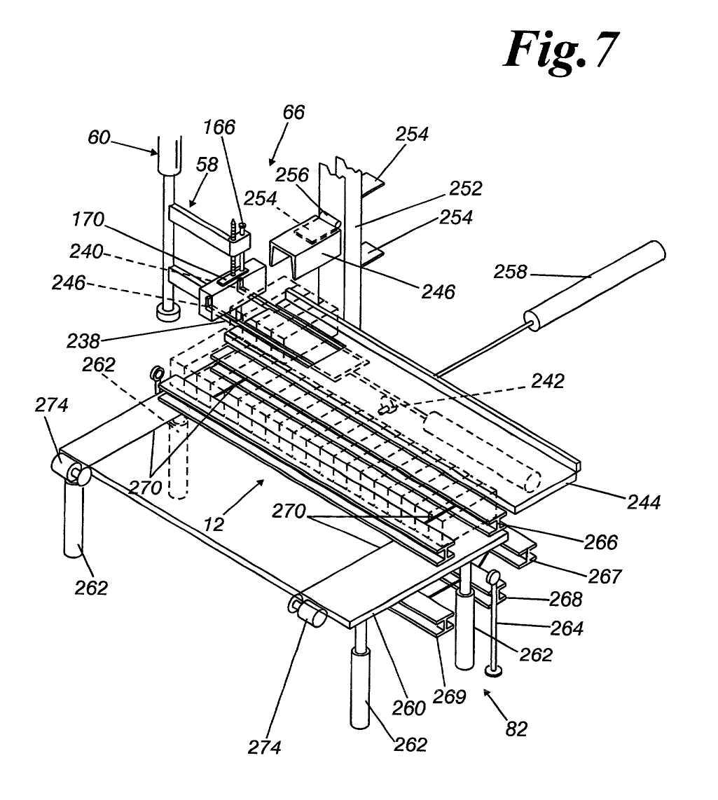

At the fourth station 62, a second cutting apparatus 72 utilizes the imaging data for alignment to remove mortar from opposing ends of the brick. The fifth station 64 also uses the imaging data to properly align a third cutting apparatus 76 for removal of mortar from the top and bottom of a demolition brick. The brick, now cleaned of mortar, moves to the sixth station 66 where the brick is released from the clamping device 58 (FIGS. 2 and 7) and mechanically stacked on the pallet 12 at the seventh station 82 (FIGS. 1 and 7).

The demolition brick recycling method and apparatus 10 is self-contained within the trailer 14 and does not require utilities to be provided at the demolition site. For example, as shown in FIG. 1, the trailer 14 houses a hydraulic oil tank 90 and pump for supplying oil to various devices, an air compressor 92 to operate pneumatic equipment such as an impact wrench, a water tank 94 and pump for providing cooling water for the cutting apparatuses 52, 72, 76, and a generator 95. The trailer floor in the cutting areas is sloped (indicated by X) towards a gutter 100 for capturing the water used to cool the cutting apparatuses 52, 72, 76 and to recycle the water for reuse. Additionally, a computer 102 is integrated with the recycling lines to control the conveying, cutting and stacking processes.

The trailer 14 can include two separate demolition brick recycling lines. By having two lines the brick recycling rate is increased. Moreover, two demolition brick types, such as for example, different sizes or colors can be simultaneously processed and stacked on separate pallets 12. When processing two different brick types, the bricks are placed in alternating rightward and leftward positions on the second conveyor 38. One recycling line removes mortar from, and stacks, bricks that are placed on the second conveyor in rightward facing positions, while the other line removes mortar from, and stacks, bricks placed in leftward facing positions on the second conveyor 38.

FIG. 1 shows stations one through seven 30, 50, 56, 62, 64, 66, 82 for one of the brick recycling lines. Since station one 30 is common to both lines and the remaining stations are essentially the same for both lines, only one line is described hereinafter except as otherwise indicated.

Referring to FIG. 2, demolition material is loaded to the sorting table 32 through the trailer entrance 18 by any suitable manner, such as a front-end loader. The sorting table 32 slopes downward from the trailer entrance 18 towards the operator to assist demolition material towards the operator. The slope of the sorting table 32 can be adjusted by a hydraulic cylinder (not shown) as necessary. The forward edge 104 of the sorting table 32 terminates above the first conveyor 34.

The first conveyor 34 is endless for receiving demolition material from the sorting table 32. The operator removes a demolition brick from either the first conveyor 34 or the sorting table 32 and places the brick face down on the second conveyor 38. A handheld air-powered hammer is provided to break apart sections of wall into individual bricks as necessary. The operator can activate the first conveyor 34 to remove demolition wastes therefrom to a trash chute 108. Although a conveyor is preferred, other methods for removing demolition wastes from the first station 30 can also be used such as, for example, a vibrating pan or a plow driven by hydraulic piston for pushing demolition waste off the sorting table 32.

The second conveyor 38 is endless and delivers demolition bricks to the first cutting apparatus 52 and thereafter to the transporter 54. The second conveyor 38 includes a fixed frame 110 upon which a series of movable trolleys 112 are disposed. The trolleys 112 are endlessly conveyed along the frame 110 by a hydraulically-driven chain 114 and are positioned in an alternating rightwards and leftwards pattern for respectively supplying demolition bricks to the first and second recycling lines.

Each trolley 112 includes a horizontal seat 120 upon which the operator places the demolition brick front face 42 down, a back plate 122 vertically extending upwards from the seat 120 to provide a rear stop position for the brick, and a pair of front and rear rollers 124, 126 which extend downward from the seat 120 to engage respective sides of the frame 110 for laterally holding the trolley 112 onto the frame 110 while allowing longitudinal movement along the frame 110. The seat 120 has a length less than the length of the brick so that the opposing ends of the brick extend beyond the seat 120. The trolley back plate 122 has a height less than the width of the brick (in the second station 50 the brick width is in the vertical direction) to allow mortar to be removed by the first cutting apparatus 52 without interfering with the back plate 122. If desired, dividers can be equal-distantly spaced between the trolleys 112 to aid the operator in properly placing the demolition brick onto the trolley 112 so that the opposing ends of the brick extend approximately the same distance beyond the seat 120.

The second conveyor 38 delivers the demolition brick to the second station 50 where a clamping wheel 132 and the first cutting apparatus 52 are provided to remove mortar from a rear face of the demolition brick. The clamping wheel 132 is cylindrical, rubberized and rotates either mechanically or by frictionally engaging the demolition brick. The clamping wheel 132 temporarily fixes the demolition brick against the back plate 122 to secure the brick during mortar removal by the first cutting apparatus 52.

The first cutting apparatus 52 is preferably a saw which is preadjusted to a cutting level determined by the width of the demolition brick. Since the front face 42 of the brick is clear of mortar and is placed downward upon the trolley seat 120, the proper cutting level remains constant from brick to brick. The saw 52 is horizontally oriented above the clamping wheel 132 and is movably mounted to transversely engage and retract from the demolition brick. Preferably, the saw 52 is biased at a fixed tension for cutting mortar from the rear face of the brick at a predetermined rate. If the saw 52 engages excessive mortar such that cutting is slowed below the predetermined rate, a sensor is activated which relays a signal to decrease the line speed of the second conveyor 38 thereby allowing the saw 52 to make a proper cut.

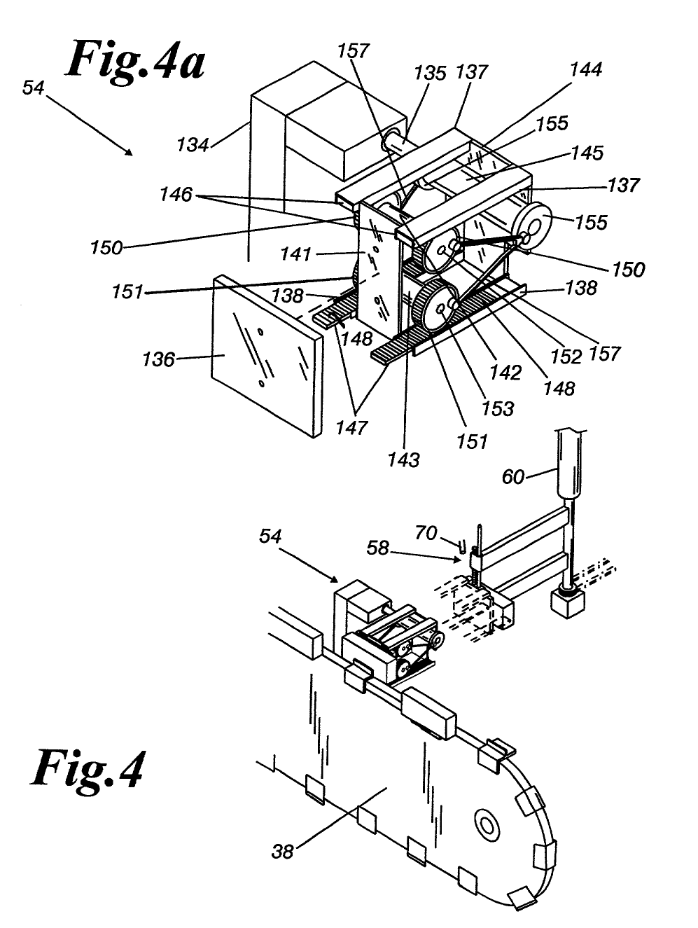

Referring to FIG. 4, after mortar is removed from the rear face of the demolition brick, the transporter 54 delivers the demolition brick from the second conveyor 38 to the third station 56 where the demolition brick is clamped to the carrier 60.

As illustrated in FIG. 4A, the transporter 54 is preferably a cam actuated device rotatably mounted to a base 134 by a motor driven shaft 135. The transporter 54 includes a frame formed of a forward plate 136, a pair of upper guides 137 and a pair of lower guides 138 mounted rearward from opposing edges of the plate, a forward carriage 141 having upper and lower sleeves 142, 143, and a rearward carriage 144 having a sleeve 145, wherein the forward and rearward carriages 141, 144 are perpendicularly disposed between the upper and lower guides 137, 138 and attached thereto. A pair of upper and a pair of lower fingers 146, 147, each having a toothed inward facing surface 148, are slidably housed within respective upper and lower guides 137, 138. The upper and lower fingers 146, 147 are extendable forwardly past the plate 136 to support the brick and retractable rearward into the guides 137, 138 to release the brick. A pair of upper cog wheels 150 and a pair of lower cog wheels 151 are mounted on axles 152, 153 rotatably disposed within the respective upper and lower sleeves 142, 143 of the forward carriage 141. The cog wheels 150, 151 have a toothed circumference which extend through channels in the guides to communicate with, advance and retract, the toothed fingers 146, 147. A pair of cams 155 is also carried by the drive shaft 135 which is rotatably housed within the rearward carriage sleeve 145. A pair of upper rods 156 ties the cams 155 to the upper cog wheels 150 to effectuate rotation from the shaft 135 to the upper cog wheels 150 and, accordingly, advance and retract the upper fingers 146. Similarly, a pair of lower rods 157 ties the cams 155 to the lower cog wheels 151 to effectuate rotation from the shaft 135 to the lower cog wheels 151 and, accordingly, advance or retract the lower fingers 147.

Referring to FIG. 4, the transporter 54 rotates 360 degrees, driven by the shaft 135, to lift the face-side down brick from the second conveyor 38, invert the brick to a face-up position, then deliver the brick to the clamp 58. (The transporter indicated by dotted lines is in the brick delivery position). When removing the brick from the second conveyor 38, the cams 155 extends the lower fingers 147 while retracting the upper fingers 146 into the upper sleeves 142. The lower fingers 147 pass from beneath, laterally outside the trolley seat 120, to engage the demolition brick face near its opposed ends and lift the brick from the second conveyor 38.

As the transporter 54 rotates clockwise towards the clamp 58, the cams 155 causes the upper fingers 146 to advance and the lower fingers 147 to retract into the lower sleeves 143. When the transporter 54 is at the vertical 90 degree position, the top or bottom side of the brick falls against the plate 136 and the upper and lower fingers 146, 147 are partially extended. At the 180 degree position and represented by dotted lines, the upper fingers 146 are fully extended and the lower fingers 147 are retracted within the lower sleeves 143. The brick, now inverted, rest against the upper fingers 146 for placing the brick face-side up in the clamp 58, as indicated in dotted lines. Note that since the transporter 54 has rotated 180 degrees, the upper fingers 146 are now beneath the brick while the lower fingers 147 are disposed above the brick.

The transporter 54 cooperates with the clamp 58 to properly set the brick face-side up in the clamp 58 by rotating clockwise downwards so that the upper fingers 146 pass opposing sides of the a lower jaw 160 of the clamp 58 and place the brick thereon. The lower fingers 147, fully retracted, do not interfere with placing the brick on the clamp 58 allowing the transporter 54 to rotate clockwise past the clamp 58 and to the second conveyor 38. As the transporter 54 rotates towards the second conveyor 38, the cams 156 cause the upper fingers 146 to retract and the lower fingers 147 to extend to pick-up another brick, and the process is repeated. In a variation of the embodiment, the transporter 54 can temporarily pause at the third station 56 until the demolition brick is secured within the clamp 58 before rotating towards the second conveyor 38.

As shown in FIG. 3, the clamp 58 extends from a first shaft 158 of the carrier 60 and includes the lower jaw 160 upon which the demolition brick is set and an upper jaw 162 horizontally disposed above the lower jaw 160. The terminal end 164 of the upper jaw 160 receives a threaded drive rod 166 and a vertical alignment rod 168. The drive rod 166 is driven by an impact wrench to advance a clamp bar 170 onto the front face 42 of the demolition brick to secure the brick within the clamp 58. Note that the operation of the transporter 54 flips each brick from face-side down (on conveyor 38) to face-side up in clamp 58. The alignment rod 168 is vertically movable through a sleeve 171 in the terminal end 164 and is secured to the clamp bar 170. The alignment rod 168 has a coned end 172 for positioning the respective second and third cutting apparatuses 72, 76 in relation to the clamp 58 at stations five 64 and six 66, as further described below. The terminal ends 164, 174 of the upper and lower jaws 160, 162 are pivotable to rotate the demolition brick into various positions for cutting.

The clamped position shown in FIG. 3 illustrates the brick having the front face 42 directed upwards with the longitudinal axis of the brick generally perpendicular to the longitudinal axis of the clamp 58. Additionally, it is important that the transporter 54 cooperates with the clamp 58 to position the demolition brick in such a manner that the clamp bar 170 is fully on the front face 42 of the demolition brick with the brick surfaces containing mortar external to the clamp bar 170.

The third station 56 also includes the imaging device 61 which is positioned above and digitally images the front face 42 of the demolition brick. The imaging data is relayed to the computer 102 (FIG. 1) where color variations between the brick and the mortar are used to determine the position of the brick within the clamp 58. Although the imaging device 61 is described as distinguishing color variations, it is intended to encompass any suitable device which can electronically distinguish the brick from the mortar and the position of the brick within the clamp 58.

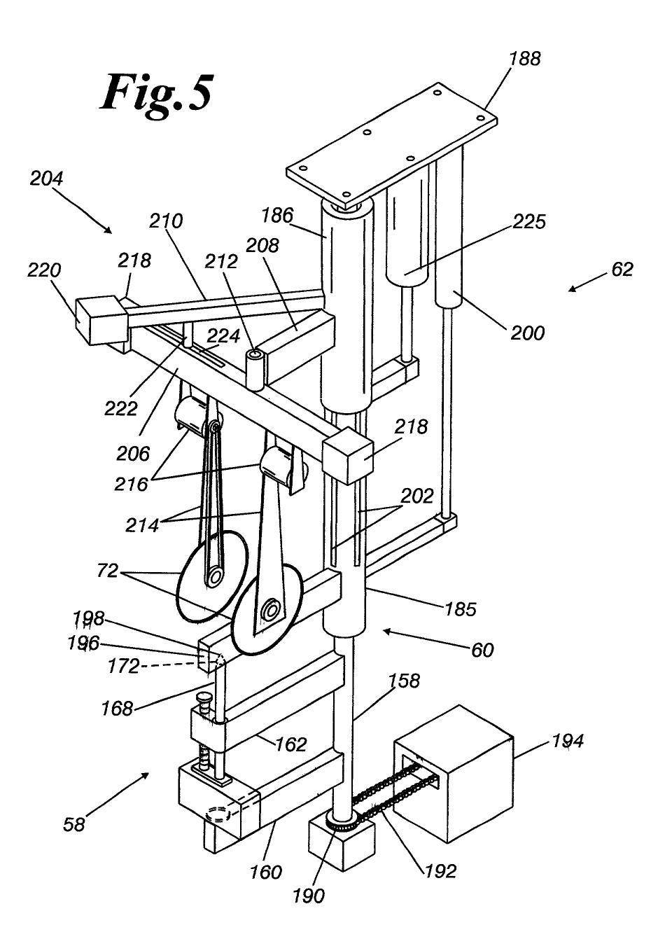

The carrier 60 rotates the clamped demolition brick in sequence from the third station 56 to the fourth, fifth and sixth stations 62, 64, 66, as illustrated in FIG. 2. Referring to FIG. 5, the carrier 60 comprises three coaxial shafts 158, 185, 186 in vertical communication. The first shaft 158 is rotatably secured at the lower end to the floor of the trailer 14 and at the upper end to the ceiling of the trailer 14 by a bracket 188. Bearings (not shown) are provided at the ends of the first shaft 158 to allow free rotation of the first shaft 158. A chain driven gear 190 is provided on the first shaft 158 with a continuous chain 192 looped from a motor 194 to the gear to rotate the first shaft 360 degrees.

The second shaft 185 is tubular and has an inner diameter greater than the outer diameter of the first shaft 158. The second shaft 185 is co-axially disposed about an intermediate portion of the first shaft 158 and vertically slides along the first shaft 158. An alignment beam 196 horizontally extends from the second shaft 185, above the clamp 58, and is provided with a coned shaped recess 198 for matingly receiving the coned end 172 of the alignment rod 168. A piston 200 is secured at one end to the trailer ceiling bracket 188 and at the other end to the second shaft 185 for vertically positioning the alignment beam 196 onto and away from the alignment rod 168.

The third shaft 186 is tubular has an inner diameter greater than the outer diameter of the second shaft 185 and is co-axially disposed about the upper end of the first and second shafts 158, 185. The third shaft 186 vertically slides along the second shaft 185. The third shaft 186 is restricted from rotating about the second shaft 185 by having longitudinal ridges (not shown) slidably received within longitudinal channels 202 of the second shaft 185. Since the second shaft 185 sets the relationship between the clamp 58 and the third shaft 186, the clamp 58 is in a known position in regards to the second cutting apparatus 72.

An orientation assembly 204 carries the second cutting apparatus, preferably a pair of saws 72, and is attached to the third shaft 186 for aligning the saws 72 in relation to the brick. Since each brick is positioned differently within the clamp 58, the orientation assembly 204 utilizes data from the imaging device 61 to accurately align the saws 72 parallel with opposed ends of the brick.

The orientation assembly 204 includes a horizontal rail 206 from which the saws 72 are suspended, a support arm 208 pivotally suspending the rail 206 from the third shaft 186, and a guide member 210 for rotating the rail 206 in a horizontal plane. The support arm 208 is affixed at one end to the third shaft 186 and is rotatably coupled to the rail 206 at the other end by a coupling pin 212. The coupling pin 212 is vertically aligned above the alignment rod 168 and defines a fixed point about which the rail 206, and consequently the saws 72, can be rotated in the horizontal plane.

The saws 72, carried by the rail 206, extend downward therefrom by a pair of arms 214 and are powered by a pair of motors 216. A pair of endless gears (not shown) longitudinally extend from each end of the rail 206 to about the midpoint of the rail 206 and are independently driven by a pair of servo motors 218. The arms 214, supporting the saws 72, extend through a longitudinal channel (not shown) in the bottom surface of the rail 206 and are attached to the respective endless gears for independently moving along the longitudinal axis of the rail 206. Alternatively, the arms 214 could be coupled to a single endless gear that extends fully along the longitudinal axis of the platform. In this alternative, the saws 72 would be preset apart a distance equivalent to the length of the brick and would remain spaced at that distance when moved along the rail 206 by a servo motor.

The guide member 210 is affixed to the third shaft 186 and is disposed above the rail 206 at about a 60 degree angle to the rail 206. An endless gear (not shown), driven by a servo motor 220, is provided along the longitudinal axis of the guide member 210. A pin 222 couples the endless gear to the rail 206 to rotate the rail 206. The first end of the pin 222 is attached to the endless gear for longitudinally moving along the guide member 210 and extends therefrom through a longitudinal channel (not shown) in the bottom surface of the guide member 210. A second end of the pin 222 is slidably entrained within a longitudinal channel 224 along the top surface of the rail 206. The pin 222 imports linear motion from the endless gear to rotate the rail 206 about the coupling pin 212. For example, to rotate the rail 206 clockwise, the endless gear advances the pin 222 towards the third shaft 186, causing the pin 222 to slide within the rail channel 224 and the rail 206 to pivot about the coupling rod 212. Accordingly, the saw blades rotate to a position parallel with the opposing ends of the brick.

A piston 225 is secured at one end to the trailer ceiling bracket 188 and at the other end to the third shaft 186 for vertically moving the third shaft 186, and consequently the saws 72, vertically towards and away from the demolition brick. The piston 225 drives the saws 72 downward at a predetermined force to cut mortar off opposing ends of the brick. Once the saws 72 have reached a through-cut position, a sensor (not shown) is activated to actuate the piston 225 to return the saws 72 to a home position.

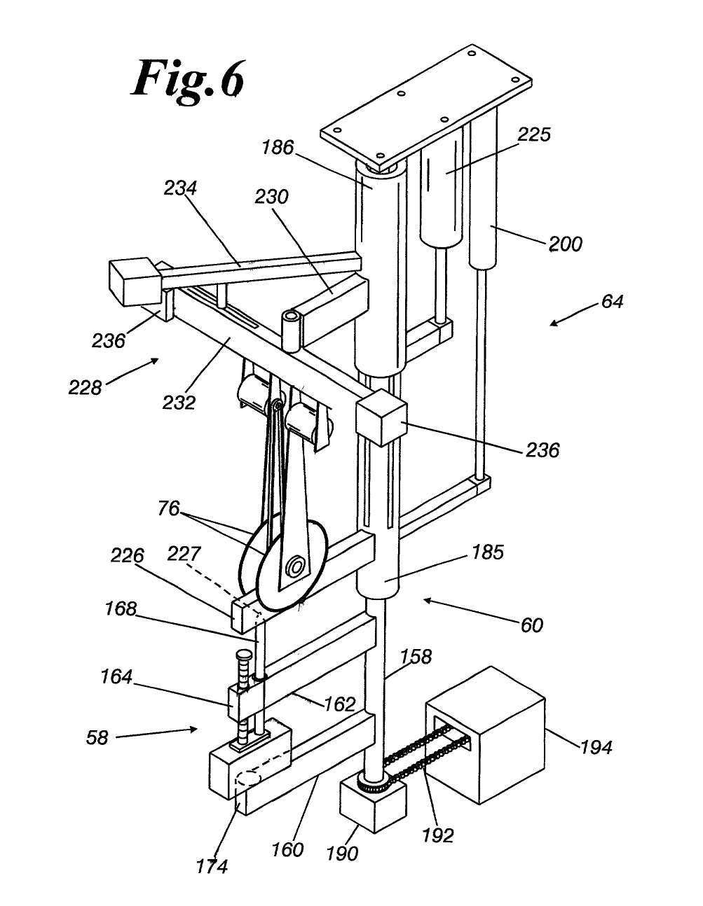

Referring to FIG. 6, the carrier 60 rotates the clamped brick from the forth station 62 to the fifth station 64 where mortar is removed from the top and bottom of the demolition brick by the third cutting apparatus, which preferably is a pair of saws 76. At the fifth station 64, the brick is rotated 90 degrees by rotating the upper and lower terminal ends 164, 174 of the clamp 58. The demolition brick, now parallel with the longitudinal axis of the clamp 58, allows for the saw blades to descend and remove mortar from the top and bottom surfaces of the brick without engaging the clamp 58.

The mortar removal process and apparatus at station five 64 is the same as at station four 62. An alignment beam 226 having a coned shaped recess 227 is mated with the alignment rod 168 for fixing the position of the clamp 58 in relation to an orientation assembly 228. The orientation assembly 228 comprises a support beam 230 extending from the carrier third shaft 186; a rail 232 rotatably coupled to the support beam 230 and carrying the saws 76; a guide member 234 for rotating the saws to a position parallel with the brick top and bottom surface; and means for adjusting the saws along the rail 232, such as a pair of endless gears (not shown) and servo motors 236, to align the saws in respective planes of the top and bottom brick surfaces. Since the orientation assembly 228 is attached to the carrier third shaft 186, the third cutting apparatus 76 is retractably raised and lowered simultaneously with the second apparatus 72 by the piston 226.

Referring to FIG. 7, the carrier 60 rotates the clamp 58 from the fifth station 64 to the sixth station 66, where the brick now cleaned of mortar is released and removed from the clamp 58 for stacking on the pallet 12. The clamp bar 170 is released from the demolition brick by retracting the drive rod 166. Hydraulic loading arms 238 having terminal ends with upward extending detents 240 moves according to cam 242 action downward and forward beneath the brick then upward and rearward so that the detents 240 retain the brick on the loading arms 238 while carrying the brick to a predetermined position on a table 244. An alternative is to use flip up fingers instead of detents 240 to aid in removing the brick from the clamp 58.

The table 244 holds an entire row of bricks. As each succeeding brick is pulled by the loading arms 238 from the clamp 58, a new brick is positioned where the previous brick was thereby advancing the previous brick along the table 244. This process continues until a predetermined number of bricks, which constitutes a row of bricks, are placed on the table 244.

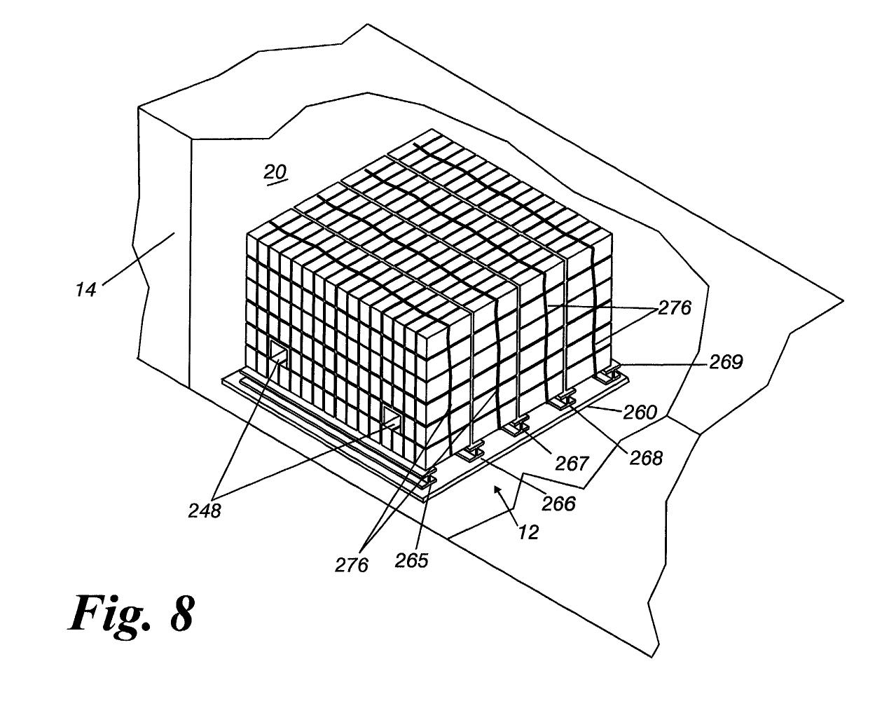

Preferably, spacers 246 are positioned in the row of bricks. As illustrated in FIG. 8, the spacers 246 are generally configured as an upside down “U” and form a pair of channels 248 once the row of bricks are placed on the pallet 12 for cooperation with a forklift. Referring to FIG. 7, a spacer feed system 250 delivers spacers 246 to the table 244 and includes an endless conveyor 252 having a series of hinged shelves 254 upon which the spacers 246 rest. The conveyer 252 is vertically oriented such that the spacers 246 are delivered from above onto the table 244. Thereafter, the shelf 254 engages the table 244 and rotates upwards about its hinge 256 to allow the shelf 254 to continue past the table 244.

The loading arms 238 have two pull lengths. The first pull length is for delivering a brick from the clamp 58 to a front position on the table 244. For the second pull length, the loading arms 238 pull the brick past the front position to allow a spacer 246 to be placed in the front position by the spacer feeding system 250.

Once the row of bricks is positioned on the table 244, a hydraulic piston 258 pushes the row of bricks from the table 244 onto the pallet 12 at the seventh station 82. The seventh station 82 includes a platform 260 upon which the pallet 12 is positioned to receive the cleaned bricks. The platform 260 is vertically movable up and down by hydraulic cylinders 262 for adjusting the pallet 12 height to receive the bricks from the table 244. A light sensor 264 identifies when the pallet 12 is at the proper height for a row of bricks to be pushed thereon and signals the hydraulic cylinders 262 to stop.

The pallet 12 is formed of a series of beams 265, 266, 267, 268, 269, such as the five shown, connected by cables 270. Initially, first and second pallet beams 265, 266 are positioned on the platform 260 while the remaining beams 267, 268, 269 are temporarily stored under the platform 260 for space considerations. A first row of bricks is pushed by the hydraulic piston 258 from the table 244 onto the first beam 265 and half of the second beam 266. The hydraulic cylinders 262 then lower the platform 260 until the light sensor 264 signals that the top of the first row of bricks is properly aligned with the table 244 for having a second row of bricks placed atop the first row. This process continuous until a predetermined number of rows of brick are stacked upon each other to form a first wall of bricks.

Once a first wall of brick is completed, the pallet 12 is pulled across the platform 260 by a pair of motors 274 attached to the cables 270 until the third beam 267 is pulled from under the platform 260 and properly positioned. Thereafter, the hydraulic cylinders 262 return the platform 260 upwards to its original level and the hydraulic piston 258 pushes a new row of bricks onto the exposed half of the second beam 266 and onto half of the third beam 267 (see FIG. 8). This row of bricks is stacked as previously described with the hydraulic cylinders 262 lowering the pallet 12 so that subsequent rows of bricks can be placed thereon. This process is continued until the bricks are fully stacked on the pallet 12, as shown in FIG. 8. Once a pallet of bricks is complete, strapping 276 can be used to tie the bricks together and the pallet of bricks is removed by forklift through the trailer exit 20. To return the beams to their original position, the motors 274 reverse to pull the third, fourth and fifth beams 267, 268, 269 under the platform 260 leaving the first and second beams 265, 266 in position for receiving a row of bricks (see FIG. 7).

In operation, demolition material delivered to the first station 30 by depositing the material onto the sorting table 32 through the trailer entrance 18. The operator sorts bricks from the demolition material and places the brick face-side down on the second conveyor 38. Demolition waste is removed from the sorting table 32 to the trash chute 108 by activating the first conveyor 34.

The second conveyor 38 carries to the brick via a trolley 112 to the second station 50 where the clamping wheel 132 temporarily holds the brick to the trolley 112 while the first cutting apparatus 52 removes mortar from the rear face of the brick.

Thereafter, the second conveyor 38 carries the brick to the transporter 54 which inverts the brick 180 degrees while delivering the brick from the second conveyor 38 to the third station 56 where the brick is clamped to the carrier 60. The brick, now face-side up, has its face digitally imaged by the imaging device 61 to determine the position of the brick in relation to the clamp 58 and/or the interface between the brick and the mortar.

The first shaft 158 of the carrier 60 rotates the clamped brick to the fourth station 62 for removing mortar from opposed ends of the brick by the second cutting apparatus 72. Since each brick may be positioned differently within the clamp 58, data gathered by the imaging device 61 is used to properly position the second cutting apparatus 72. The second shaft 185 of the carrier 60 is moved downwards by the hydraulic piston 200 towards the clamp 58 until the alignment beam 196 of the carrier 60 mates with the clamp alignment rod 168. Upon mating, the clamp 58 is held in a fixed relationship with the orientation assembly 204 carried by the carrier third shaft 186.

The orientation assembly 204 adjusts the second cutting apparatus 72 for removing mortar from the brick by first rotating the rail 206 in a horizontal plane until the second cutting apparatus 72 is parallel with opposed ends of the brick. Second, the second cutting apparatus 72 is longitudinally moved to the same plane as the opposed ends of the brick. Third, the hydraulic piston 226 moves the second cutting apparatus 72 downward to remove mortar from the opposed brick ends.

The carrier 60 then delivers the brick to the fifth station 64. At the fifth station 64, the clamped brick is rotated 90 degrees so that the longitudinal axis of the brick is parallel with the longitudinal axis of the clamp 58. In this position the top and bottom surfaces of the brick are accessible to the third cutting apparatus. The alignment beam 226 and the orientation assembly 228 are operated as discussed in the fourth station 62 to align the third cutting apparatus and remove mortar from the top and bottom brick surfaces. The brick is now cleaned of motor and in condition for reuse in construction.

The carrier 60 then delivers the cleaned brick to the sixth station 66 where the brick is released from the clamp 58 and placed onto the table 244 by the loading arm 238. Spacers 246, delivered by the conveyor 252, are placed on the table 244 between the bricks as necessary. Once a row of bricks is positioned on the table 244, the hydraulic piston 258 pushes the bricks from the table 244 onto the pallet 12.

The pallet 12, formed of a series of beams, is horizontally and vertically movable to allow subsequent rows of bricks to be stacked on the pallet 12. Once the pallet 12 is fully stacked with bricks, the bricks are bounded by strapping 276 and are removed from the trailer exit 20 by a forklift.

Although specific apparatus has been described for the seven stations and means for delivering the demolition brick to the stations, it will be understood that a variety of alternative devices are also suitable. For example, mortar removal from the brick can be performed by water jet (water lacing), hydraulic shear blade, diamond wire rope, grinding and sand blasting. Additionally, the conveyance of demolition brick can be performed by a wide variety of conveyors, and other devices. Furthermore, other known means can be used to position the brick and the cutting apparatus for removing mortar from the brick.

It is to be understood that the foregoing description and specific embodiments are merely illustrative of the best mode of the invention and principals thereof, and that various modifications and additions may be made to the apparatus by those skilled in the art, without departing from the spirit and scope of this invention, which is therefore understood to be limited only by the scope of the appended claims.

What is claimed is:

1. A method for removing mortar from a brick, comprising:
providing a computer controlled automated system which includes the steps of:
providing a first device for holding a brick;
holding the brick with said first device;
removing mortar from the rear of the brick;
removing mortar from opposing ends of the brick; and
removing mortar from the top and bottom of the brick.

2. The method according to claim 1, further comprising the step of determining the interface between the brick and mortar.

3. The method according to claim 1, further comprising the steps of providing a second device for determining the position of the brick and determining with said second device the position of the brick.

4. The method according to claim 3, wherein said second device is an imaging device.

5. The method according to claim 4, claim further comprising the step of imaging the front face of the brick.

6. The method according to claim 1, further comprising the steps of providing a first cutting device for removing mortar from the rear of the brick and removing mortar from the rear of the brick with said first cutting device.

7. The method according to claim 6, further comprising the steps of providing a second cutting device for removing mortar from the opposing ends of the brick and removing mortar from the opposing ends with said second cutting device.

8. The method according to claim 7, further comprising the steps of providing a third cutting device for removing mortar from the top and bottom of the brick and removing mortar from the top and bottom of the brick with said third cutting device.

9. The method according to claim 8, wherein said second cutting device is a first pair of saws.

10. The method according to claim 9, wherein said third cutting device is a second pair of saws.

11. The method according to claim 10, further comprising the steps of providing a first means for positioning said second cutting device for removing mortar from opposing ends of the brick, and a second means for positioning said third cutting device for removing mortar from the top and bottom of the brick.

12. The method according to claim 11, wherein said first and second positioning means moves said second cutting device in three dimensional space and said second positioning means moves said third cutting device in three dimensional space.

13. The method according to claim 12, further comprising the steps of providing an imaging device for determining the position of the brick and determining with said imaging device the position of the brick, and wherein said first positioning means, said second positioning means and said imaging device are disposed above the brick.

14. The method of claim 13, further comprising the steps of positioning said first and second cutting devices according to the position of the brick as determined by said imaging device.

15. The method according to claim 1, further including the step of providing at least one means for transporting the brick between said first, second and third cutting devices.

16 The method according to claim 1, further comprising the step of stacking bricks onto a pallet and wherein said first device is a clamping device.

17. An automated brick recycling apparatus for removing mortar from a brick, comprising:
a first cutting device for removing mortar from the rear of the brick;
a second cutting device for removing mortar from an end of the brick;
a third cutting device for removing mortar from a top of the brick;
an imaging device for determining the orientation of the brick;
at least one transport device for transporting the brick from said first cutting device to said second and third cutting devices; and
a computer, wherein said cutting devices, said transport device, and said imaging device are automated and controlled by said computer.

18. The brick recycling apparatus according to claim 17, further comprising a movable trailer wherein said trailer houses said automated brick recycling apparatus.

19. The brick recycling apparatus according to claim 17, wherein said first, second and third cutting devices are saws.

20. The brick recycling apparatus according to claim 18, wherein said second cutting device and said third cutting device are movable in three dimensions.
